(19) United States
(12) Patent Application Publication
(10) Pub. No.: US 2004/0012281 A1
(43) Pub. Date: Jan. 22, 2004

(54) Actuator with limited travel and emergency upcoupling

(76) Inventors: Achim Neubauer, Sinzheim-Vormberg (DE); Joerg Aschoff, Buehl (DE); Werner Dilger, Buehl (DE); Rolf Pierenkemper, Buehlertal (DE); Martin-Peter Bolz, Buehl (DE)

Correspondence Address: Striker Striker & Stenby, 103 East Neck Road, Huntington, NY, 11743, US

(21) Appl. No.: 10/343,364

(22) PCT Filed: Dec. 14, 2001
(86) PCT No.: PCT/DE01/04759

(30) Foreign Application Priority Data
Feb. 5, 2001 (DE) 101 05 032.1

(51) Int. Cl. F16H 19/00

(52) U.S. Cl. 310/75 R

(57) ABSTRACT

The invention relates to an actuator drive mechanism with a control motor (1), which on the power takeoff side drives a control gear that includes a final control element (3) on the drive side and a final control element (5) on the power takeoff side, and the final control element (5) on the power takeoff side cooperates with an adjusting element (11), by way of which engines or machines can be varied in their operating behavior. Associated with the final control element (3, 5) on the drive side or the power takeoff side is a power takeoff component (8), which includes a force-transmission-free region (25), and on which a spring element (21) is received movably in a recess (19).

### FIELD OF THE INVENTION

In actuator drive mechanisms in use today to actuate couplings or gears, electric motors are typically used. A worm, for instance, is formed onto their armature shaft. This worm cooperates with a worm wheel and optionally other gear stages provided. As a rule, worm drives are designed such that self-inhibition is involved; that is, once an actuating position between the worm and the worm wheel has been assumed, it can be changed or undone again only with a considerable exertion of force. Thus if there is a power failure at the actuator drive mechanism that drives the worm drive, a displacement that is now necessary and must be performed can be achieved only at increased effort.

### PRIOR ART

In vehicles that are driven with internal combustion engines, whether they are utility vehicles or passenger cars, exhaust gas turbochargers can be used, so that during the intake stroke of the engine better filling of the individual cylinders of the engine with gas can be achieved, whether the engine is a direct-injection type or a mixture-compressing engine with externally supplied ignition. If exhaust gas turbochargers are displaced via an electric motor, which comprises a worm drive with a worm and a worm wheel, and/or are provided with a rack and pinion assembly, then on the power takeoff side, not only a linear but a rotary motion can be generated, by way of which the guide blade rings of an exhaust gas turbocharger can be displaced, and its operating behavior and effectiveness can be varied. A power failure at the actuator drive mechanism is a major problem, since even if there is a power failure, a displacement at the exhaust gas turbocharger, to name one example, must be assured. Thus an exhaust gas turbocharger with a variable turbine geometry that is actuatable by means of an electric actuator drive mechanism, in the closed guide vane position, which in this state allows the passage of a flow of exhaust gas, must be capable of being opened again quickly if there is a power failure at the actuator drive mechanism associated with it. Fast opening of the guide blade ring is required if, for an engine whose exhaust system contains the exhaust gas turbocharger, the driver suddenly “steps on the gas”. In this state, however, the flow of exhaust gas, which expands as it flows through the exhaust turbine but when the guide blade ring is closed is prevented from passing through the flow machine at the exhaust gas turbocharger, could cause considerable damage.

With actuator drive mechanisms in use today, it is extremely difficult to react to a power failure at an actuator drive mechanism that has a tendency to self-inhibition.

### SUMMARY OF THE INVENTION

The embodiment proposed according to the invention does not permit any transmission of force to the final control element in one control region of the actuator drive mechanism. A final control element that functions when without current is provided, which if there is a power failure assures a residual displaceability. This can be achieved by making modifications in actuator drive mechanisms in present used; with the embodiment proposed according to the invention, if there is a power failure, the “open” state can be brought about quickly at the final control element to be actuated, since only short rotation paths have to be traversed. With the arrangement proposed according to the invention, a spring can be connected parallel to a drive mechanism, reinforcing the drive of the final control element; for instance, together with the electric motor, the guide blade ring of a turbocharger can be kept closed during braking.

The disconnection of adjusting elements from final control elements, as proposed according to the invention, allows the same parts to continue to be used in driving components, since only slight modifications have to be made in known drive motors in present use, which advantageously means that retrofitting costs are saved.

The embodiment proposed according to the invention permits a disconnection of final control elements over the entire path of rotation of a final control element. The restoring effect is thus assured by the spring element, provided parallel to the actuator drive mechanism, referred to one complete revolution of the affected final control element, both before the reversal of the tension direction and after the reversal of the tension direction of the spring element, during the rotation of the final control element. This is attained by providing that the spring element is retained movably via a pin guided in a groove of the final control element and is supported by its other end at a fixed but rotatable point. In normal operation, in which an adjusting element acted upon by the final control element is moved back and forth between two extreme positions, the spring is always taut. Upon the revolution of the final control element, the pivot point of the spring element, which point is guided movably in the final control element, is displaced, so that after a half-revolution of the final control element, a maximum tension exists in the spring element. If in this rotary position the current at the drive motor failures, then the energy of the spring element stored in the spring element can move the final control element into a position in which it is disengaged from the adjusting element, for example by way of an interruption in its external toothing.

If the current at the actuator drive mechanism fails before the reversal of force of the spring element, then the adjusting element can be moved automatically into the “open” position by the spring element and the load. In that case, an overrotation of the final control element into the zone without force transmission is unnecessary.

In a further variant embodiment of the concept on which the invention is based, instead of adapted spring elements, an electromagnetic coupling and decoupling, or connection and disconnection, can also be achieved.

### DRAWING

The invention is described in further detail below in conjunction with the drawing.

Shown are:

FIG. 1, the schematic layout of a conventional actuator drive mechanism with a worm gear, rack and pinion;

FIGS. 2.1 through 2.4, a schematic illustration of the disconnection principle of a rack and pinion assembly, in which the pinion is received coaxially to a worm wheel;

FIG. 3, an illustration of the superposition of the courses of the force of the spring element, the fictive load, and the resultant load for the actuator drive mechanism; and

FIG. 4, the basic layout of an electromagnetic spring system for the emergency disconnect in the state with and without current.

### VARIANT EMBODIMENTS

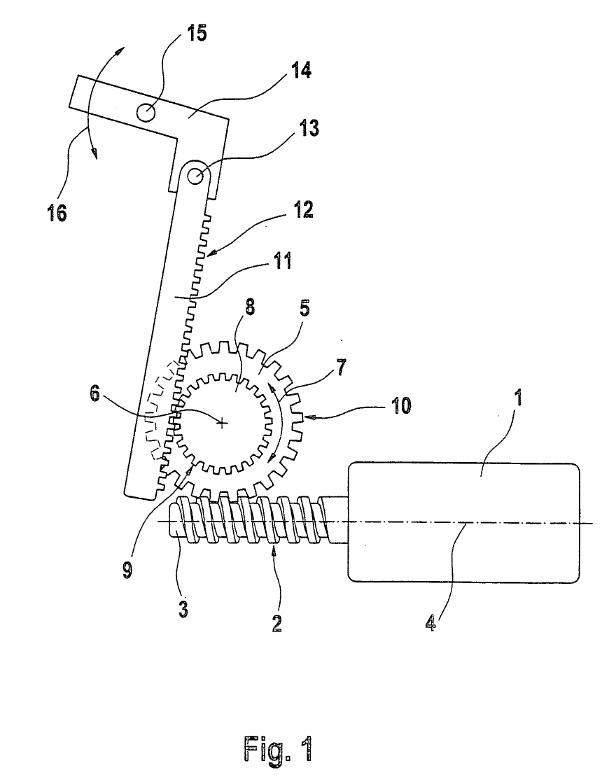

From the view in FIG. 1, the schematic layout of a conventional actuator drive mechanism with a worm gear, rack and pinion is seen in further detail.

In this view of an actuator drive mechanism of a typical type today, with a control motor 1 and a worm gear 3, 5 and an adjusting element 11 in the form of a rack, the control motor 1 drives the worm gear 3, 5. The armature shaft 2 of the control motor 1, which coincides with the line of symmetry 4 of the control motor, is provided with a worm thread, which cooperates with an external toothing 10 on the worm wheel 5. The rotary axis 6 of the worm wheel 5 extends perpendicular to the plane of the drawing; that is, the worm wheel 5 and worm 3 are oriented at a right angle to one another. A power takeoff component 8 in the form of a pinion with external teeth is provided coaxially and rigidly relative to the worm wheel 5. Depending on the direction of rotation of the control motor 1, a motion of the worm wheel 5 in one of the directions, represented by the double arrow 7, is initiated via the established direction of rotation. The power takeoff component 8, with its external toothing 9, cooperates with a rack 11, which in the view of FIG. 1 acts as an adjusting element. The rack 11 is provided with teeth 12 on its side oriented toward the power takeoff component 8. The rack functioning as an adjusting element 11 is received rotatably, on its upper end 13, on an L-shaped lever 14. The lever is in turn movable about a pivot shaft 15; the pivoting direction is represented by the double arrow, which is identified by reference numeral 16.

With the arrangement that is schematically shown in FIG. 1, a linear motion can be generated, in accordance with the vertical up-and-down motion of the rack 11 functioning as an adjusting element, as represented by the double arrow 16. Instead of a linear motion, a rotary motion can also be brought about by means of an adjusting element 11. In these typical adjusters, if there is a power failure at the control motor 1, a displacement is possible only with relatively high forces, if at all. This has the disadvantage that for numerous potential applications, an actuator drive mechanism of this kind represents a major problem in performing a displacement at the adjusting element 11 in the event of a power failure. This can become critical, particularly whenever, in machines such as exhaust gas turbochargers that are located in the exhaust system of an internal combustion engine with greatly fluctuating operating states (these are known as VTG chargers), displacements of the guide blade ring, for instance from the closed to the open state, have to be made when there is a power failure. In an exhaust gas turbocharger of variable turbine geometry, for instance, it can be urgently necessary to open a closed guide blade ring if the driver suddenly “steps on the gas”, to protect this machine in the exhaust system of an internal combustion engine from damage.

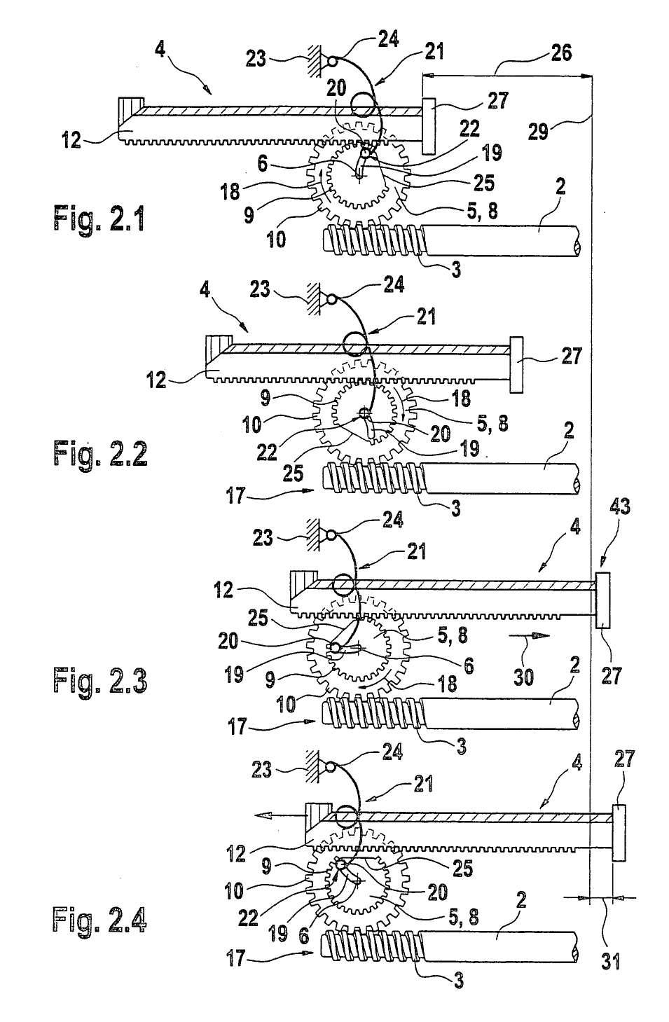

From the drawing cycle shown in FIGS. 2.1 through 2.4, a schematic illustration of a disconnection principle, proposed according to the invention, for a rack and pinion assembly can be seen in more detail; the pinion with external toothing that functions as the power takeoff component is received coaxially to the worm wheel.

In the view shown in FIG. 2.1, the thread of a worm 3 is embodied on an armature shaft 2 of a control motor 1, not shown in FIG. 2.1. This thread meshes with a male thread 10 of a worm wheel 5 that rotates about a rotary axis 6. A power takeoff component 8 is shown coaxially to the worm wheel 5 of the worm gear 3, 5; in the view of FIG. 2.1, it is embodied as a pinion with teeth on the outside, its external toothing 9 being interrupted in one region 25. In the view of FIG. 2.1, a recess 19 in the form of a longitudinal groove is let into the pinion 8 with external teeth that serves as the power takeoff component. One boundary of the recess 19 coincides with the rotary axis 6 of the worm wheel 5 and power takeoff component 8, while the outer boundary of the recess 19 in the form of a longitudinal groove, which recess may be embodied in the worm wheel 5 or in the power takeoff component 8, ends below the external toothing 9.

Above an adjusting element 11, such as a rack provided with an external toothing 12, a spring element 21 is suspended from a fixed bearing 23 in a stationary articulation 24. The spring element 21 may for example be embodied as a wrap spring, a spiral spring, or the like, which with its end opposite the fixed bearing 23 is supported in a movable pivot point 22, in the form of a pin 20 guided in the recess 19.

The rack functioning as an adjusting element 11 is provided with a stop 27, which in the view of FIG. 2.1 is located at a distance, located at reference numeral 26, from a reference position 29. On the end opposite the stop 27 of the rack that acts as an adjusting element 11, there is a chamfer. In the view in FIG. 2.1, the adjusting element 11 is in its first extreme position 42, which can for example be the position in which, in an exhaust gas turbocharger of variable turbine geometry contained in the exhaust system of an internal combustion engine, the guide blade ring is placed in its open position. When current is being supplied to the control motor 1, or in other words in the normal operating mode, the spring element 21 is relatively only slightly tensed.

In FIG. 2.2, as a result of the rotation of the armature shaft 2 with the worm gear received on it, which gear meshes with the worm teeth 10 of the worm wheel 5, the pinion 8 with external teeth that functions as the power takeoff component has rotated onward in the direction of rotation 18 by a good quarter-revolution. During this quarter-rotation, the stop 27 of the rack, provided with a toothing 12 and functioning as an adjusting element 11, has moved toward the reference edge 29. During this quarter-rotation, the external toothing 9 of the externally toothed pinion acting as the power takeoff component and the teeth 12 of the racklike adjusting element 11 mesh with one another. During this quarter-rotation described in FIG. 2.2, the recess 19, whether it is embodied in the power takeoff component 8 or in the worm wheel 5, has rotated accordingly, and the spring element 21, for instance configured as a wrap spring, is slowly tensed further. During this partial rotation, the pin 20, which is guided movably in the recess 19 and acts as the movable articulation 22 of the spring element 21, has moved in the recess 19 in the direction of the rotary axis 6 of the worm wheel 5 or of the power takeoff component 8, so that no later than approximately a half-revolution of the worm wheel 5 or of the power takeoff component 8, the spring element is maximally tensed. This course of motion has the advantage that upon further rotation, until reaching the second extreme position 43 (see FIG. 2.3), the spring element 21 of the rack functioning as the adjusting element 11 has reinforced the control motor somewhat, which can for instance be utilized so that in this position, the spring element 21 together with the control motor 1 keeps a guide blade ring of an exhaust gas turbocharger closed during braking. Upon reverse rotation out of the position shown in FIG. 2.2, the spring element would relax again, and the pin 20 would move back again in the groove 19.

From FIG. 2.3, it can be seen that the stop 27 of the adjusting element 11 has moved outward to beyond the reference edge 29; that is, the adjusting element 11 has assumed its second extreme position 43. In the view shown in FIG. 2.3, the teeth 12, mounted on the outside of the adjusting element 11, and the external toothing 9 of the pinion 8 acting as a power takeoff component still just barely mesh. In this extreme position 43 shown in FIG. 2.3, if the current at the control motor 1—the latter not shown here—fails, then the spring element, by its prestressing, brings about an overrotation of the worm wheel 5, or of the pinion 8 with external teeth, in such a way that the pinion 8 or worm wheel 5 is overrotated to such an extent that no further engagement of teeth occurs between the external toothing 9 of the power takeoff component 8 and the teeth 12 of the adjusting element 11. This is accomplished by further rotation of the power takeoff component 8 or worm wheel 5 in the direction of rotation 18, so that the region 25 of the power takeoff component that has no teeth is located below the external toothing 12 of the racklike adjusting element 11. As a result, the adjusting element 11 becomes freely movable relative to the power takeoff component 8 or to the worm wheel 5.

In FIG. 2.4, it is shown that the racklike adjusting element 11 is freely movable relative to the power takeoff component 8 or the worm wheel 5. The stop 27 of the adjusting element 11 has moved past the reference edge 29 by a distance 31, in which there is no longer any tooth engagement, that is, force transmission, between the adjusting element 11 of the power takeoff component 8 and the worm wheel 5. In this state, the chamfer embodied on the adjusting element 11 runs up onto a winding of the wrap spring 21, so that the rack 11, which is disengaged, is moved out of its second extreme position 43 back in the direction of its first extreme position 42, as represented by the arrow shown at the chamfer in FIG. 2.4. This is accomplished as a result of the fact that the wrap spring 21, pivotably connected at the stationary fixed bearing 23 and guided movably in the recess 19, is not yet completely relaxed and still has a residual tensing force.

The residual spring force that the spring element 21, embodied for instance as a wrap spring, still has no longer suffices to rotate the worm wheel 5 or power takeoff component 8 onward counter to the detent moment of the control motor 1 and the losses that occur in the worm drive 3, 5, and so the gear stays in the position shown in FIG. 2.4, and the rack functioning as the adjusting element 11 can be moved freely for instance by means of the blade forces in the guide blade ring that occur in the exhaust gas turbocharger. The worm gear 3, 5 is designed in terms of its tooth geometries such that no self-inhibition occurs.

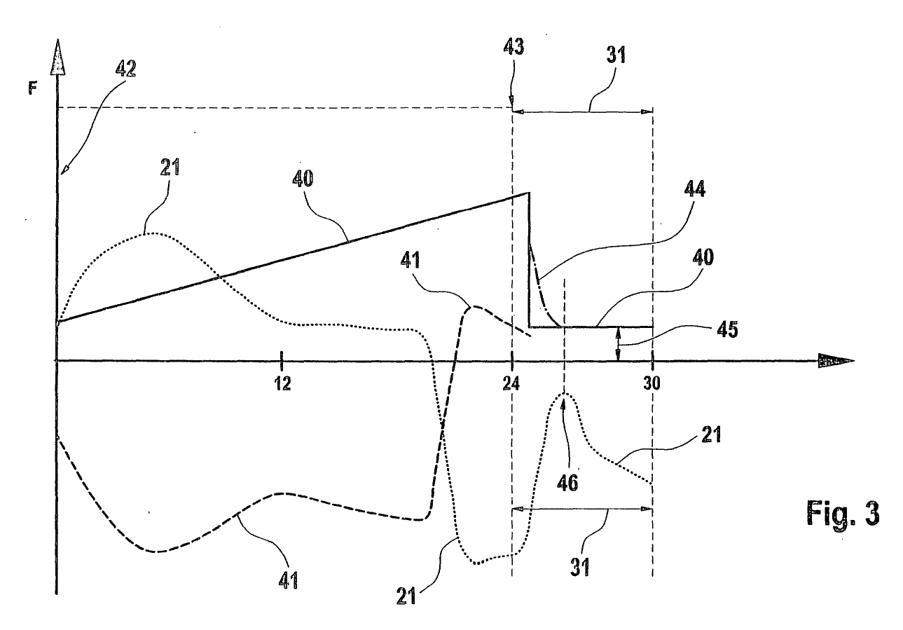

FIG. 3 shows a view illustrating the superposition of the courses of the force of the spring element, a fictive load, and the resultant load for the actuator drive mechanism, plotted over the travel distance.

As seen from FIG. 3, the spring element 21 is already taut in the first extreme position 42, which corresponds to the open position of the rack functioning as the adjusting element 11, and thus the control motor 1 has to work counter to the spring force and to the fictive load 40. If a motion of the power takeoff component 8 or worm wheel 5 or rack 11 in the direction of the second extreme position 43, which is equivalent to a closed position, now takes place, then the load increases virtually linearly, as represented by the curve course 40, and the spring element is tensed further; that is, the spring force acting counter to the control motor 1 increases still further. As a result of the rotation of the power takeoff component 8, in the form of a pinion with external teeth, the angle of the spring element relative to the rack functioning as the adjusting element 11 changes, and the pin 20, by way of which the spring element 21 is connected to the power takeoff component 8, migrates inward in the groovelike recess 19. As a consequence, with increasing travel of the adjusting element 11 in the direction of the second extreme position 43, the spring force decreases again beyond a certain point, and then remains virtually constant over a relatively long distance or angular range relative to the power takeoff component 8. However, since the load increases further linearly, the result is a somewhat curvate course of the resultant motor load, represented by the curve course 41.

Just before the second extreme position 43 is reached, the pin 20 slips outward again in the recess 19 on the power takeoff component 8, and the spring prestressing of the spring element 21 acts in the opposite direction. This means that in this travel range, the control motor has to brake counter to the spring force exerted by the spring element 21. Until the second extreme position 43 is reached, the braking/motor load then decreases again somewhat, since the load increases further and the spring force decreases somewhat. When current is being supplied to the control motor 1, the system always moves between the first and second extreme positions 42 and 43, respectively.

If the power fails in the second extreme position 43, or after the reversal of the tension direction of the spring element 21, then the spring element 21 pulls the pinion with external teeth, functioning as the power takeoff component 8, into the zone marked 31, in fact so far that the teeth of the external toothing 10 of the power takeoff component 8 and the teeth 12 of the rack functioning as the adjusting element 11 no longer mesh with one another.

Counter to the remaining worm losses 45, the pinion acting as the power takeoff component 8 rotates still some way farther until it reaches its extreme position; see FIG. 2.4. A chamfer on the end of the rack 11 serves to push it back again partway in the direction of the first extreme position 42, utilizing the residual spring force available, and thus to enable a limited displacement travel during operation without current.

If the current at the control motor 1, conversely, fails in a rotary position of the power takeoff component 8 or worm wheel 5 before the reversal of force of the spring element 21, then the rack acting as the adjusting element 11 automatically moves by means of the load and the spring into the first extreme position 42—an overrotation of the power takeoff component 8 into the zone 31 is not required.

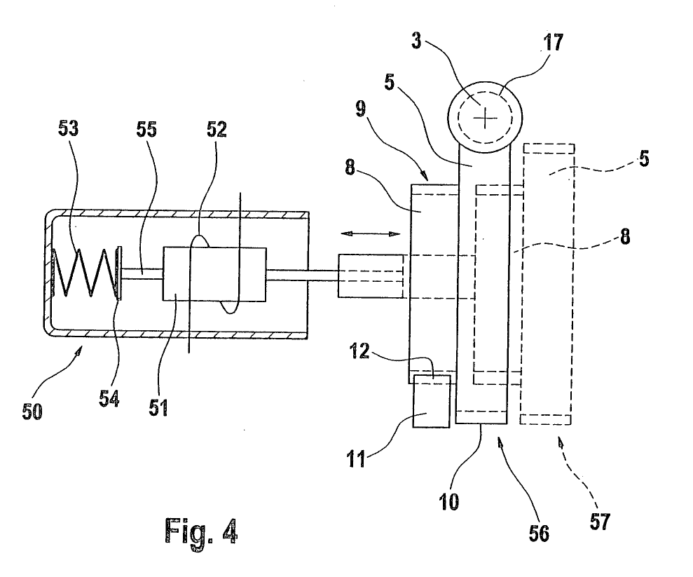

From the view in FIG. 4, the basic layout of an electromagnetic spring system for disconnection in an emergency is shown in further detail, in the states with and without current.

In this illustration, a spring element 53 is kept in the taut state inside an electromagnetically operating valve 50 by a coil 52 through which current flows. The spring prestressing is brought to bear by the iron core 51 that penetrates the coil 52 through which current flows; this core, by means of a rod 55 with a plate attachment 54 provided on it, acts upon the spring element 53 inside the housing of the electromagnetic valve 50. If there is a power failure, the electromagnetic field collapses abruptly, and via the iron core 51, the spring element 53 presses a peg in the horizontal direction as represented by the double arrow. As a result, the engagement position of the worm 3 and worm wheel 5, which is identified by reference numeral 56 and represents the state of the electromagnetic valve 50 with current, can be overcome, by relative displacement of the worm wheel 5. As a result, on the one hand the worm wheel 5 become disengaged from the worm 3, and on the other, the external toothing 9 of the power takeoff component 8 becomes disengaged from the teeth 12 of the racklike adjusting element 11. The spring element presses the coaxial assembly comprising the power takeoff component 8 and the worm wheel 5 into the position marked 57, representing the state without current. For displacement of the rack, shown shaded here in FIG. 4 and acting as the adjusting element 11, a further adjusting element would have to be provided that functions when without current.

### LIST OF REFERENCE NUMERALS

1 Actuator drive mechanism

2 Armature shaft

3 Worm

4 Line of symmetry

5 Worm wheel

6 Worm wheel axis

7 Direction of rotation

8 Power takeoff component (pinion)

9 External toothing

10 External toothing of worm wheel 5

11 Rack

12 Toothing

13 Pivot point of rack

14 Lever

15 Pivot shaft

16 Pivoting direction

17 Worm thread

18 Direction of rotation

19 Recess

20 Pin

21 Spring element

22 Movable articulation

23 Fixed bearing of spring element

24 Stationary articulation

25 Portion without teeth

26 Actuation stroke

27 Stop

28 Pivoting range

29 Reference stroke

30 Direction of motion of rack

31 Zone

40 Load course

41 Resultant motor load

42 First extreme position (open)

43 Second extreme position (closed)

44 Restoration discontinuity

45 Worm losses

46 Spring force in “state without current”

50 Electromagnetic valve

51 Iron core

52 Coil carrying current

53 Spring element

54 Plate attachment

55 Rod

56 State with current

57 State without current

1. An actuator drive mechanism with a control motor (1), which on the power takeoff side drives a control gear (3, 5) that includes a final control element (3) on the drive side and a final control element (5) on the power takeoff side, and the final control element (5) on the power takeoff side cooperates with an adjusting element (11), by way of which engines or machines can be varied in their operating behavior, characterized in that associated with the final control element (3, 5) on the drive side or the power takeoff side is a power takeoff component (8), which includes a force-transmission-free region (25), and on which a spring element (21) is received movably in a recess (19).

2. The actuator drive mechanism of claim 1, characterized in that the power takeoff component (8) is supported coaxially and rigidly relative to the final control element (5) on the power takeoff side.

3. The actuator drive mechanism of claim 1, characterized in that the power takeoff component (8) is embodied as a pinion with external toothing (9).

4. The actuator drive mechanism of claim 1, characterized in that the spring element (21) is embodied as a wrap spring.

5. The actuator drive mechanism of claim 1, characterized in that the recess (19) in the power takeoff component (8) or in the final control element (5) on the power takeoff side is embodied as a groove.

6. The actuator drive mechanism of claim 5, characterized in that a stop of the groove (19) coincides with the rotary axis (3) of the power takeoff component (8) or of the final control element (5) on the power takeoff side.

7. The actuator drive mechanism of claim 5, characterized in that the spring element (21) is received at its stationary pivot point (24) at a distance from the rotary axis (6) of the power takeoff component (8) or of the final control element (5) on the power takeoff side.

8. The actuator drive mechanism of claim 1, characterized in that during the rotation of the power takeoff component (8), the spring element (21) assumes its maximum deflection at approximately a half-revolution of the power takeoff component (8) or of the final control element (5) on the power takeoff side.

9. The actuator drive mechanism of claim 8, characterized in that if there is a power failure at the control motor (1) before the half-revolution of the power takeoff component (8) is reached, the adjusting element (11) is displaced in the direction of its first extreme position (42) by the load and force of the spring element (21).

10. The actuator drive mechanism of claim 8, characterized in that if there is a power failure at the control motor (1) after the completion of the half-revolution of the power takeoff component (8), the power takeoff component (8) is overrotated in the direction of rotation (18), so that the adjusting element (11) and the power takeoff component (8) are disengaged in one region (25).

11. The actuator drive mechanism of claim 1, characterized in that the adjusting element (11) is provided with a runup chamfer, which upon contact with the spring element (21) enables a displaceability of the adjusting element (11).

12. An actuator drive mechanism with a control motor (1), which on the power takeoff side drives a control gear (3, 5) that includes a final control element (3) on the drive side and a final control element (5) on the power takeoff side, and the final control element (5) on the power takeoff side cooperates with an adjusting element (11), by way of which engines or machines can be varied in their operating behavior, characterized in that a coil (52) is associated with a spring element (53) in an electromagnetic valve (50), and the iron core (51) acting as the coil core disengages the final control elements (3, 5) and/or the power takeoff component (8) and adjusting element (11), if there is a power failure at the coil (52).
